(19) United States
(12) Patent Application Publication
(10) Pub. No.: US 2006/0252441 A1
(43) Pub. Date: Nov. 9, 2006

(54) System and method for programming an inactivity timer

(76) Inventors: John M. Harris, Chicago, IL (US); Samuel D. Fernandez, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/120,825

(22) Filed: May 3, 2005

(51) Int. Cl. H04B 1/38; H04B 7/00; H04Q 7/20

(52) U.S. Cl. 455/518; 455/90.2

(57) ABSTRACT

One or more characteristics of a PTT bearer message exchange between an originating mobile station (102) and a target mobile station (120) is determined. An expiration period of the inactivity timer (108) is programmed based upon the one or more characteristics of the PTT bearer message exchange.

### FIELD OF THE INVENTION

The field of the invention relates to routing communications through networks and, more specifically, to reducing unnecessary data traffic to components of a network.

### BACKGROUND OF THE INVENTION

In communication systems, inactivity timers measure periods of time when no events of interest occur in the system. If the timer expires with no event of interest occurring, an appropriate action may be taken. In one example of the use of an inactivity timer, when a data transfer between a mobile station and base station becomes interrupted, an inactivity timer counts down an inactivity timeout interval. Channel resources are released by the system if another data transfer between the base station and the mobile station is not initiated during this timeout interval.

In Push-to-Talk (PTT) systems, a substantial percentage of calls are split when a participant becomes inactive. In many PTT systems, an inactivity timer is used to release resources after the timer expires. However, if the resources are dropped at the target of the next PTT, the system must page over an entire area to again find the participant in order to resume the call. This paging results in two different types of system costs: a paging interval delay, while the system waits for the target to wake up next, and paging channel load, which is the load generated on the paging channel in every sector in that paging zone while looking for that target. Additionally, if the resources are dropped at the originator of the next PTT, then that PTT must also be placed on traffic channel. More resources are expended if the next PTT target releases resources, than if the next PTT originator releases resources.

Some previous inactivity timers in PTT systems were programmed to have fixed expiration periods. However, since the length of the timer period was fixed and often set to a long period of time, resources were held for long periods even after the PTT dialog between participants had ended. This led to inefficient resource allocation since available resources were withheld from other participants that needed the resources. Additionally, if the expiration period were long, the mobile stations remained active and unnecessarily drained power from their battery.

In other previous systems, variable timers sometimes were used. While being able to change the timer period, these approaches also proved inadequate to solve the above-mentioned problems because they relied on traffic modeling of aggregate traffic loads, and this technique did not adequately predict future system behavior. Consequently, channel resources were still not adequately conserved and unnecessary battery consumption at mobile stations was not reduced.

### BRIEF DESCRIPTION OF THE DRAWINGS

FIG. 1 is a diagram showing one example of a system for setting an inactivity timer according to the present invention;

FIG. 2 is a diagram showing one example of a mobile station that uses an inactivity timer according to the present invention; and

FIG. 3 is a flowchart showing one approach to setting an inactivity timer according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for setting the inactivity timer in a mobile communication system determines the expiration period of the timer by examining the characteristics of messages that are exchanged within the system. The approaches described herein conserve battery power of mobile stations and result in the efficient allocation of system resources.

In many of these embodiments, one or more characteristics of a PTT bearer message exchange between an originating mobile station and a target mobile station is determined. The bearer message may be part of a private call or, alternatively, a group call. An expiration period of the inactivity timer is programmed based upon the one or more characteristics of the PTT bearer message exchange. The characteristic may be the direction of a bearer message in the bearer message exchange, the relative direction between subsequent user bearer messages in message exchange, the number of bearer messages in the call, the duration and length of a bearer message in the message exchange, the content of a bearer message in the message exchange, the type of bearer message in the message exchange, the number of participants involved in the message exchange, the link quality achieved in the message exchange, or any physical characteristic of the mobile station involved in the message exchange. Other examples of characteristics are possible.

The period of the inactivity timer may be lengthened or shortened depending upon the circumstances. For instance, the period of the inactivity timer may be shortened when a content of a bearer message in the message exchange is more than a threshold amount correlated with a previous bearer exchange, where the previous bearer exchange is the last exchange within a previous call. In another example, the period of the inactivity timer may be shortened when the previous message was in the opposite direction of the current message and the message exchange occurs after a third PTT talk burst within the message exchange. In still another example, the period of the inactivity timer may be lengthened when the previous message was in the opposite direction of the message exchange and the PTT bearer exchange is the second PTT talk burst within the call.

Thus, approaches are described herein that conserve the battery life of mobile stations while also efficiently allocating resources in the system. The splitting of calls is also reduced thereby resulting in less paging attempts being made and further conserving system resources. Since system resources are conserved in these approaches, the resources can be allocated to tasks that truly require the resources thereby further increasing system efficiency.

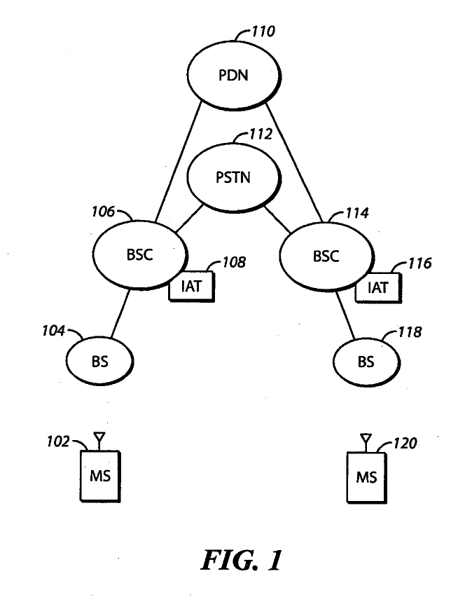

Referring now to FIG. 1, one example of a system for programming an inactivity timer is described. The system includes a base station 104. The base station 104 is coupled to a base station controller 106, and the base station controller 106 includes an inactivity timer 108. The base station controller 106 is connected to another base station controller 114 via a packet data network (PDN) 110 and the Public Switched Telephone System (PSTN) 112. The base station controller 114 includes an inactivity timer 116 and is coupled to a base station 118. A mobile station 102 may be communicatively coupled to the base station 104, and a mobile station 120 may be communicatively coupled to the base station 118.

The base stations 104 and 118 include all the functionality needed to communicate with the mobile stations 102 and 120. In this regard, they may include transmitters and receivers that communicate with the mobile stations 102 and 120. The mobile stations 102 and 120 may be cellular telephones, pagers, personal digital assistants (PDAs) or laptop computers. Other examples of mobile stations are possible.

The base station controllers 106 and 114 route data between the networks 110 and 112 and the mobile stations 102 and 120. As mentioned, the base station controllers 106 and 114 also include the inactivity timers 108 and 116. The inactivity timers are variable timers that have a programmable expiration period. It will be understood that the inactivity timers, although shown as being associated with base station controllers 106 and 114, may be associated with other components of the system. For instance, the inactivity timers 108 and 116 may be associated with the base stations 104 and 118. In another example, the inactivity timers 108 and 116 may be associated with the mobile stations 102 and 120.

In one example of the operation of the system of FIG. 1, one or more characteristics of a PTT bearer message exchange between an originating mobile station 102 and a target mobile station 120 is determined. An expiration period of the inactivity timer is programmed based upon the one or more characteristics of the PTT bearer message exchange. The bearer message may be part of a private call or, alternatively, a group call. The characteristic may be selected from a number of examples such as the direction of the bearer message in the bearer message exchange, the relative direction between subsequent user bearer messages in the message exchange, the number of bearer messages in the call, the duration and length of a bearer message in the message exchange, the content of a bearer message in the message exchange, the type of bearer message in the message exchange, the number of participants involved in the message exchange, the link quality achieved in the message exchange, or any physical characteristic of the mobile station involved in the message exchange. Other examples of characteristics are possible.

As mentioned, entities within the system exchange bearer messages. In a PTT call, an application level user bearer message refers to the audio talkspurt itself. Additionally, the direction of the last bearer message, refers to the direction of the last talkspurt. For example, if Alice presses the PTT button and then speaks to Bob, then Bob presses the PTT button, and talks to Alice, the direction of the last bearer message is from Bob to Alice. The last bearer message from Bob to Alice is based on the direction of the last talk burst and not based on the direction of the last actual data packet flowing between Bob and Alice. For example, if Bob completes the PTT talk burst to Alice, the last packet, could have been transmitted from Alice back to Bob, providing a presence update or acknowledging the receipt of the talk burst or providing some other sort of information. Regardless, in this case, the last bearer exchange was from Bob to Alice because the actual audio itself was sent by Bob to Alice.

The period of the inactivity timers 108 or 116 may be lengthened or shortened from the current period depending upon the results of applying the characteristic to a predetermined algorithm. For instance, the period of the inactivity timer 108 or 116 may be shortened when a content of a bearer message in the message exchange is more than a threshold amount correlated with a previous bearer exchange, where the previous bearer exchange is the last exchange within a previous call. In another example, the period of the inactivity timer 108 or 116 may be shortened when the previous message was in an opposite direction of the current message and the message exchange occurs after the third PTT talk burst within the message exchange. In still another example, the period of the inactivity timer 108 or 116 may be lengthened when the previous message was in the opposite direction of the message exchange and the PTT bearer exchange is the second PTT talk burst within the call. Other combinations of characteristics may also be used to shorten or lengthen the expiration period.

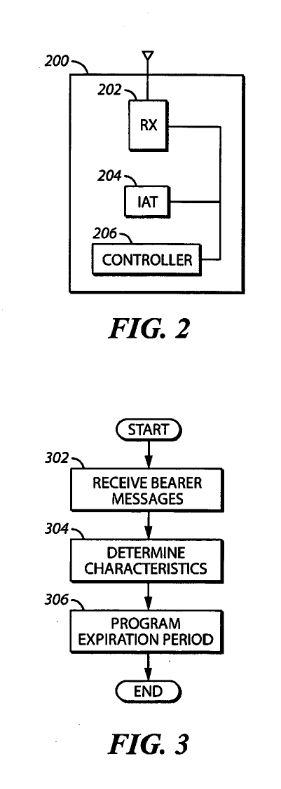

Referring now to FIG. 2, a mobile station 200 includes a receiver 202, an inactivity timer 204, and a controller 206. The controller 206 is coupled to the receiver 202 and inactivity timer 204. As mentioned elsewhere in this specification, the inactivity timer may be placed in other system components besides the mobile stations such as the base station or the base station controller.

The controller 206 is programmed to determine one or more characteristics of a push-to-talk (PTT) bearer message exchange between an originating mobile station and a target mobile station and to set an expiration period of the inactivity timer based upon applying the one or more characteristics of the PTT bearer message exchange to a predetermined algorithm. The controller 206 may monitor the bearer exchange at the output of the receiver 202. Examples of characteristics and algorithms are described elsewhere in this specification.

Referring now to FIG. 3, one example of an approach for setting the expiration period of an inactivity timer is described. At step 302, bearer messages are received. The bearer messages may be received at any appropriate network device. For example, they may be received at a mobile station, a base station, or at a base station controller. The messages may be received at other locations as well.

At step 304, single or multiple characteristics of the bearer messages are determined. As described elsewhere in this specification, the characteristic or characteristics may be selected from a number of examples such as the direction of a bearer message in the bearer message exchange, the relative direction between subsequent user bearer messages in the message exchange, the number of bearer messages in the call, the duration and length of a bearer message in the message exchange, the content of a bearer message in the message exchange, the type of bearer message in the message exchange, the number of participants involved in the message exchange, the link quality achieved in the message exchange, or any physical characteristic of the mobile station involved in the message exchange. Other examples are possible.

At step 306 an expiration period for the timer is determined and programmed into the inactivity timer based upon the determined characteristics. Specifically, the period of the inactivity timer may be lengthened or shortened depending upon these characteristics and applying these characteristics to some predetermined algorithm. For instance, the period of the inactivity timer may be shortened when the content of a bearer message in the message exchange is more than a threshold amount correlated with previous bearer exchanges. In another example, the period of the inactivity timer may be shortened when the previous message was in the opposite direction of a current message and the message exchange occurs after a third PTT talk burst within the message exchange. In still another example, the period of the inactivity timer may be lengthened when the previous message was in the opposite direction of the message exchange and the PTT bearer exchange is the second PTT talk burst within the call. Other examples are possible.

Other adjustments to the inactivity timer and components of other system elements are possible depending upon the value of the measured characteristics and the results of applying the characteristic to the predetermined algorithm. For example, the inactivity timer may be programmed to provide an increased level of tracking movement of the target mobile station depending upon the circumstances. The target mobile station may also be programmed to wake up more frequently to receive paging requests during certain time frames. Additionally, the time for the target mobile station to scan a control channel for control messages may also be increased depending upon qualities of the bearer message exchange.

Thus, approaches are described herein that conserve the battery life of mobile nodes while also efficiently allocating resources in the system. The splitting of calls is also reduced thereby resulting in less paging attempts being made and further conserving system resources. Since system resources are conserved in these approaches, the resources can be allocated to other tasks further increasing system efficiency.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for programming an inactivity timer associated with a push-to-talk (PTT) bearer message call comprising:
determining one or more characteristics of a PTT bearer message exchange between an originating mobile station and a target mobile station; and
programming an expiration period of the inactivity timer based upon the one or more characteristics of the PTT bearer message exchange.

2. The method of claim 1 wherein determining one or more characteristics comprises determining one or more characteristics selected from a group comprising: a direction of a bearer message in the bearer message exchange; a relative direction between subsequent user bearer messages in message exchange; a number of bearer messages in the call; a duration and length of a bearer message in the message exchange; a content of a bearer message in the message exchange; a type of bearer message in the message exchange; a number of participants involved in the message exchange; a link quality achieved in the message exchange; and a physical characteristic of a mobile station involved in the message exchange.

3. The method of claim 1 wherein programming the expiration period comprises programming the expiration period to be a longer period than a current period.

4. The method of claim 1 wherein programming the expiration period comprises programming the expiration period to be a shorter period than a current period.

5. The method of claim 1 wherein determining the one or more characteristics comprises determining one or more characteristics of a PTT bearer message exchange, wherein the PTT bearer message exchange is part of a private call.

6. The method of claim 1 wherein determining the one or more characteristics comprises determining one or more characteristics of a PTT bearer message exchange, wherein the PTT bearer message exchange is part of a group call.

7. The method of claim 1 further comprising setting the inactivity timer associated to provide an increased level of tracking movement of the target mobile station.

8. The method of claim 1 further comprising causing the target mobile station to wake up more frequently to receive paging requests.

9. The method of claim 1 further comprising increasing a time for the target mobile station to scan a control channel for control messages.

10. The method of claim 1 further comprising shortening the period of the inactivity timer when a last application level user bearer message was received by the target mobile station.

11. The method of claim 1 further comprising shortening the period of the inactivity timer when a content of a bearer message in the message exchange is more than a threshold amount correlated with a previous bearer exchange, the previous bearer exchange being the last exchange within a previous call.

12. The method of claim 1 further comprising shortening the period of the inactivity timer when a previous message was in an opposite direction of a current message and the message exchange occurs after a third PTT talk burst within the message exchange.

13. The method of claim 1, further comprising lengthening the period of the inactivity timer when a previous message was in an opposite direction of the message exchange and the PTT bearer exchange is the second PTT talk burst within the call.

14. A method for programming an inactivity timer associated with a push-to-talk (PTT) bearer message call comprising:
receiving one or more characteristics of a PTT bearer message exchange between an originating mobile station and a target mobile station at a target mobile station; and
programming an expiration period of the inactivity timer based upon the one or more characteristics of the PTT bearer message exchange.

15. The method of claim 14 wherein receiving the one or more characteristics comprises receiving one or more characteristics selected from a group comprising: a direction of a bearer message in the bearer message exchange; a number of bearer messages in the call; a duration and length of a bearer message in the message exchange; a content of a bearer message in the message exchange; a type of bearer message in the message exchange; a number of participants involved in the message exchange; a link quality achieved in the message exchange; and a physical characteristic of a mobile station involved in the message exchange.

16. The method of claim 14 wherein programming the expiration period comprises programming the expiration period to a period selected from a group comprising longer period than a current period and a shorter period than a current period.

17. A mobile station comprising:
a receiver having an input;
an inactivity timer; and
a controller coupled to the receiver and the inactivity timer, the controller being programmed to determine one or more characteristics of a push-to-talk (PTT) bearer message exchange between an originating mobile station and a target mobile station and to set an expiration period of the inactivity timer based upon the one or more characteristics of the PTT bearer message exchange.

18. The mobile station of claim 17 wherein the one or more characteristics is selected from a group comprising: a direction of a bearer message in the message exchange; a number of bearer messages in the call; a duration and length of a bearer message in the message exchange; a content of a bearer message in the message exchange; a type of bearer message in the message exchange; a number of participants involved in the message exchange; a link quality achieved in the message exchange; and a physical characteristic of a mobile station involved in the message exchange.

19. The mobile station of claim 17 wherein the controller is further programmed to set the expiration period to be a longer period than a current period.

20. The mobile station of claim 17 wherein the controller is further programmed to set the expiration period to be a shorter period than a current period.
